(19) United States
(12) Patent Application Publication
(10) Pub. No.: US 2015/0134671 A1
(43) Pub. Date: May 14, 2015

(54) METHOD AND APPARATUS FOR DATA DISTRIBUTION AND CONCURRENCE

(71) Applicant: TENCENT TECHNOLOGY (SHENZHEN) COMPANY LIMITED, Shenzhen (CN)

(72) Inventors: JIEWEN LIN, Shenzhen (CN); XIAOPENG CAI, Shenzhen (CN); XIONGFENG ZHU, Shenzhen (CN); WU HU, Shenzhen (CN); YANG LIU, Shenzhen (CN)

(73) Assignee: TENCENT TECHNOLOGY (SHENZHEN) COMPANY LIMITED

(21) Appl. No.: 14/604,659

(22) Filed: Jan. 23, 2015

Related U.S. Application Data
(63) Continuation of application No. PCT/CN2014/082790, filed on Jul. 23, 2014.

(30) Foreign Application Priority Data
Aug. 15, 2013 (CN) 2013-10357205.0

(51) Int. Cl. G06F 17/30

(52) U.S. Cl. CPC G06F 17/30336; G06F 17/30371
USPC 707/741

(57) ABSTRACT

Methods and apparatus for data distribution and concurrence are provided. Data and a primary key of the data are obtained. A sub-key is assigned according to the primary key. The data are routed to a corresponding queue according to the sub-key. A writing operation is processed to the data in the queue. Because multiple sub-keys can exist under a same primary key and each sub-key can have one place for the writing operation, the writing operation can be processed simultaneously to the multiple sub-keys without affecting one another. The success rate of data writing concurrence can be improved and timeliness of the data can be ensured.

### CROSS-REFERENCES TO RELATED APPLICATIONS

This application is a continuation application of PCT Patent Application No. PCT/CN2014/082790, filed on Jul. 23, 2014, which claims priority to Chinese Patent Application No. 2013103572050, filed on Aug. 15, 2013, the entire content of both of which is incorporated herein by reference.

### FIELD OF THE DISCLOSURE

The present disclosure generally relates to the field of internet application technology and, more particularly, relates to methods and apparatus for data distribution and concurrence.

### BACKGROUND

Event notifications often use applications for comprehensive notifications, including a game notification, a birthday notification, an information notification, etc. The notification data use a time-point as a primary key. For example, a primary key can be T (time), and notifications occurred at time T can all be written into a recorder of T. Storage devices are often used and configured with anti-concurrence protection due to requirements on consistency. That is, only one piece of data may be written successfully and other pieces of data may be written with failure. Meanwhile, notification data require a high degree of timeliness. There are no chances to re-try once the data have been written with failure. Conventional event notification may have a low success rate of writing data in concurrence due to the anti-concurrence protection of the storage devices. Because the event notification is an important aspect of computer technology dealing with networked applications, technical solutions are needed to solve and/or improve the issues associated with the conventional event notification methods and systems.

Thus, there is a need to overcome these and other problems of the prior art and to provide methods and apparatus for data distribution and concurrence.

### BRIEF SUMMARY OF THE DISCLOSURE

One aspect or embodiment of the present disclosure includes a data distribution and concurrence method. Data and a primary key of the data can be obtained. A sub-key can be assigned according to the primary key. The data can be routed to a corresponding queue according to the sub-key. A writing operation can be processed to the data in the queue.

Another aspect or embodiment of the present disclosure includes a data distribution and concurrence apparatus. The apparatus can include an obtaining module, an assigning module, and a writing-storing module. The obtaining module can be configured to obtain data and a primary key of the data. The assigning module can be configured to assign a sub-key according to the primary key. The writing-storing module can be configured to route the data to a corresponding queue, and to process a writing operation to the data in the queue, according to the sub-key.

Another aspect of the present disclosure includes a non-transitory computer-readable medium having computer program. When being executed by a processor, the computer program performs a data distribution and concurrence method. The method includes obtaining data and a primary key of the data, assigning a sub-key according to the primary key, and routing the data to a corresponding queue according to the sub-key and processing a writing operation to the data in the queue.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for data distribution and concurrence consistent with various disclosed embodiments;

FIG. 2 depicts an exemplary step for assigning a sub-key according to a primary key consistent with various disclosed embodiments;

FIG. 3 depicts an exemplary process of performing a writing operation to data in a queue consistent with various disclosed embodiments;

FIG. 4 depicts another exemplary method for data distribution and concurrence consistent with various disclosed embodiments;

FIG. 5 depicts an exemplary apparatus for data distribution and concurrence consistent with various disclosed embodiments;

FIG. 6 depicts an internal structure of an exemplary assigning module consistent with various disclosed embodiments;

FIG. 7 depicts an internal structure of an exemplary writing-storing module consistent with various disclosed embodiments;

FIG. 8 depicts another exemplary apparatus for data distribution and concurrence consistent with various disclosed embodiments;

FIG. 9 depicts an exemplary environment incorporating certain disclosed embodiments; and

FIG. 10 depicts an exemplary computer system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

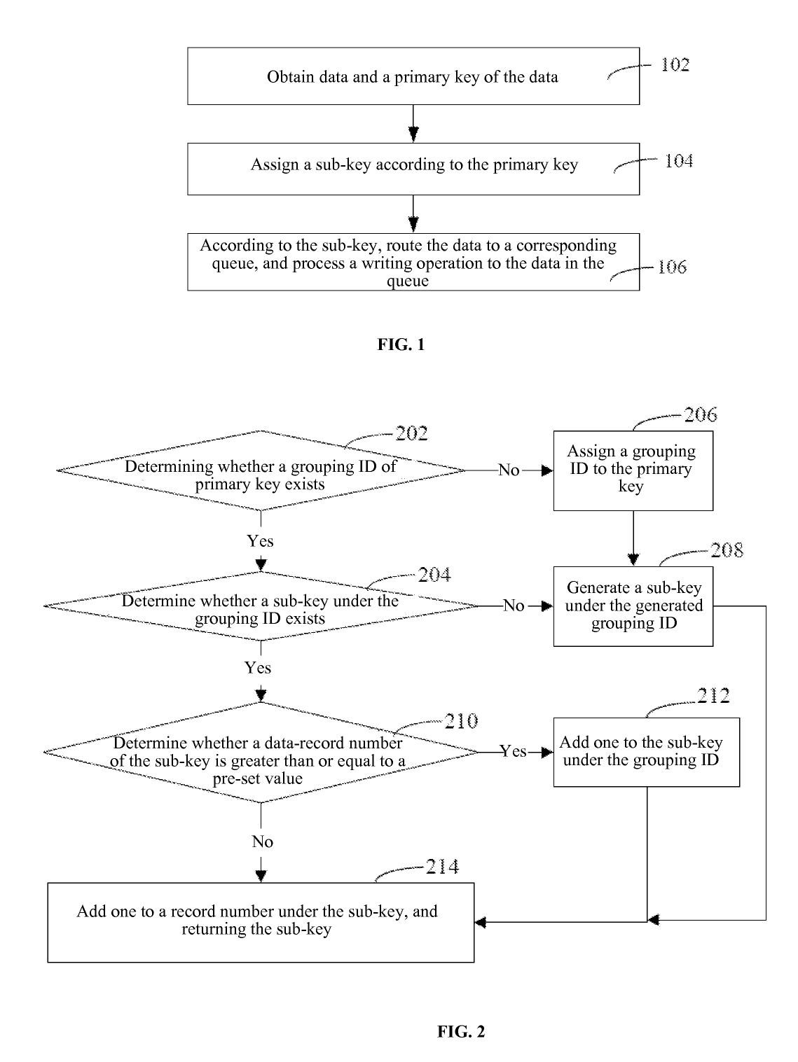

FIGS. 1-8 depict exemplary methods and apparatus for data distribution and concurrence consistent with various disclosed embodiments. For example, FIG. 1 depicts an exemplary method for data distribution and concurrence consistent with various disclosed embodiments.

In Step 102, data and a primary key of the data can be obtained. For example, the data can be any notification data that need to be sent out. The data can include, e.g., a birthday notification, an information notification, etc. In one example, the primary key of the data can be specific notification time, such as at around 10:10 on Aug. 13, 2013.

In Step 104, a sub-key according to the primary key can be assigned. For example, the primary key can be divided into multiple sub-keys, which can be assigned correspondingly to the data. The primary key can be an index of a storing system for the notification data and used to manage the sub-keys.

FIG. 2 depicts an exemplary step for assigning a sub-key according to a primary key consistent with various disclosed embodiments.

In Step 202, it is determined whether a grouping ID of the primary key exists. When the grouping ID of the primary key exists, Step 204 can be implemented. When the grouping ID of the primary is determined that does not exist, Step 206 can be implemented.

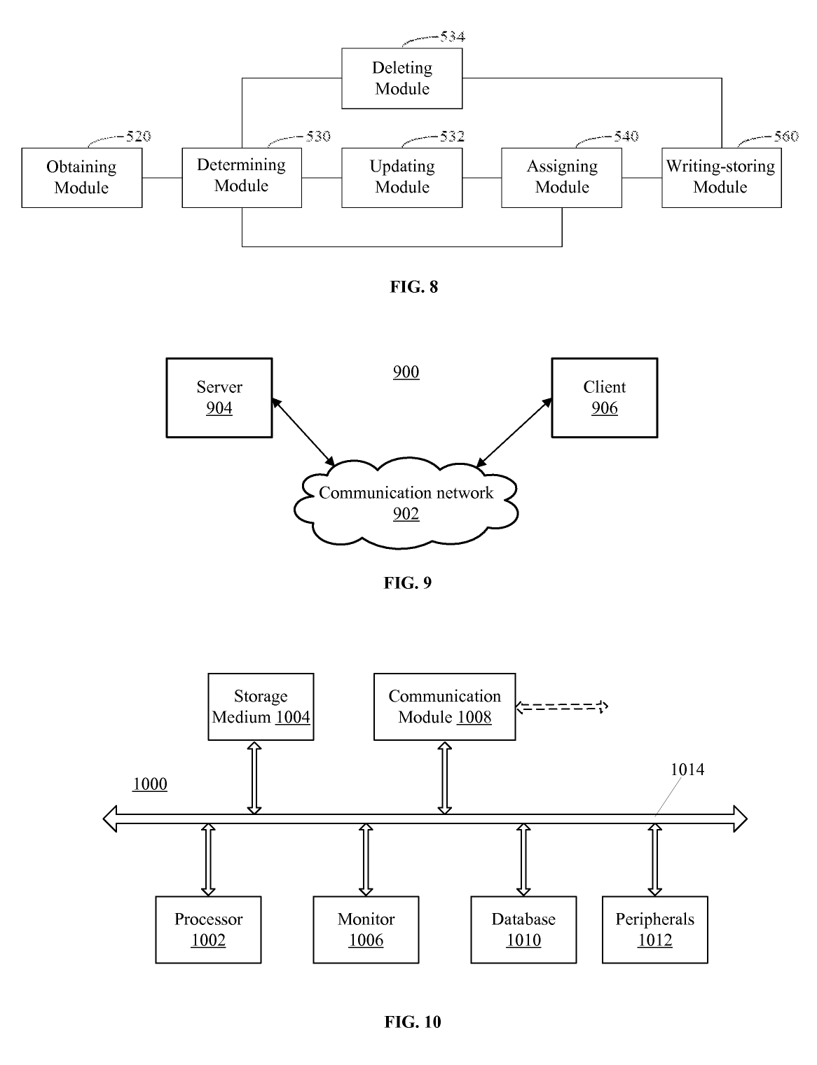

For example, according to the application request of the primary key and in stateless routing to the server, it is then determined whether a grouping ID of the primary key exists on the server. As used herein, the term “stateless routing to the server” includes equally assigning the network request to corresponding server(s), according to loading and connection success rate of each server. The grouping ID can be a grouping number and the grouping ID is unique. In various embodiments, the server can be the server depicted in FIG. 9.

In Step 204, it is further determined whether a sub-key is under the grouping ID. When the sub-key exists under the grouping ID, Step 210 can be implemented. When the sub-key does not exist under the grouping ID, Step 208 can be implemented.

In Step 206, a grouping ID can be assigned to the primary key, then Step 208 can be implemented. In Step 208, a sub-key can be generated under the grouping ID, then Step 214 can be implemented.

In Step 210, it is determined whether a data-record number of the sub-key is greater than or equal to a pre-set value. When the data-record number of the sub-key is determined to be greater than or equal to the pre-set value, Step 212 can be implemented. When the data-record number of the sub-key is determined not to be greater than or equal to the pre-set value, Step 214 can be implemented.

For example, under the sub-key, a maximum data-record number can be pre-set as the pre-set value. The pre-set value can be determined according to the size of the storage device and the retrieval efficiency of the internal data of the sub-key.

In Step 212, the sub-key, under the grouping ID, then Step 214 can be implemented. In Step 214, the record number can be added by one under the sub-key, and the sub-key can be returned.

For example, after the sub-key has been added by one under the grouping ID, the data-record number can be added by one under the updated sub-key, and the updated sub-key. When the data-record number of the sub-key is determined to be less than the pre-set value, the data-record number can be added by one under the sub-key, and the sub-key can be returned.

In addition, when it is determined that the data-record number of the sub-key is greater than or equal to the pre-set value, the corresponding sub-key can be re-assigned for the primary key.

In Step 106 of FIG. 1, according to the sub-key, the data can be routed to a corresponding queue, and a writing operation can be processed to the data in the queue. For example, data having a same sub-key can be routed into a same queue. According to hash algorithm of the sub-key, some sub-key queues can be placed in a same machine (e.g., computer) to ensure that one sub-key only has one place for the writing operation.

FIG. 3 depicts an exemplary process of performing a writing operation to data in a queue consistent with various disclosed embodiments. In Step 302, a writing process can be started. In Step 304, a queue can be locked. For example, by locking a queue, only writing operation can be processed to the queue. In Step 306, data from the locked queue can then be read. For example, the data can be read according to the order in the queue.

In Step 308, it is determined whether the queue is empty. When the queue is determined to be empty, Step 310 can be implemented. When the queue is determined not to be empty, Step 312 can be implemented. In Step 310, a next queue can be traversed. The method can then return to Step 304. For example, each queue can be accessed sequentially according to an order. In Step 312, a writing operation can be processed to the data in the queue. By traversing the queue one after another, the data can be read. The writing operation can be processed.

The disclosed data distribution and concurrent method can assign a corresponding sub-key according to a primary key of the data, then route the data of each sub-key to a corresponding queue, and then process a writing operation to the data in the queue. Because multiple sub-keys exist under a same primary key and each sub-key can only have one place (e.g., the queue) for the writing operation, the writing operation can be processed simultaneously to the multiple sub-keys without affecting one another. The success rate of data writing concurrence can be improved and timeliness of the data can be ensured.

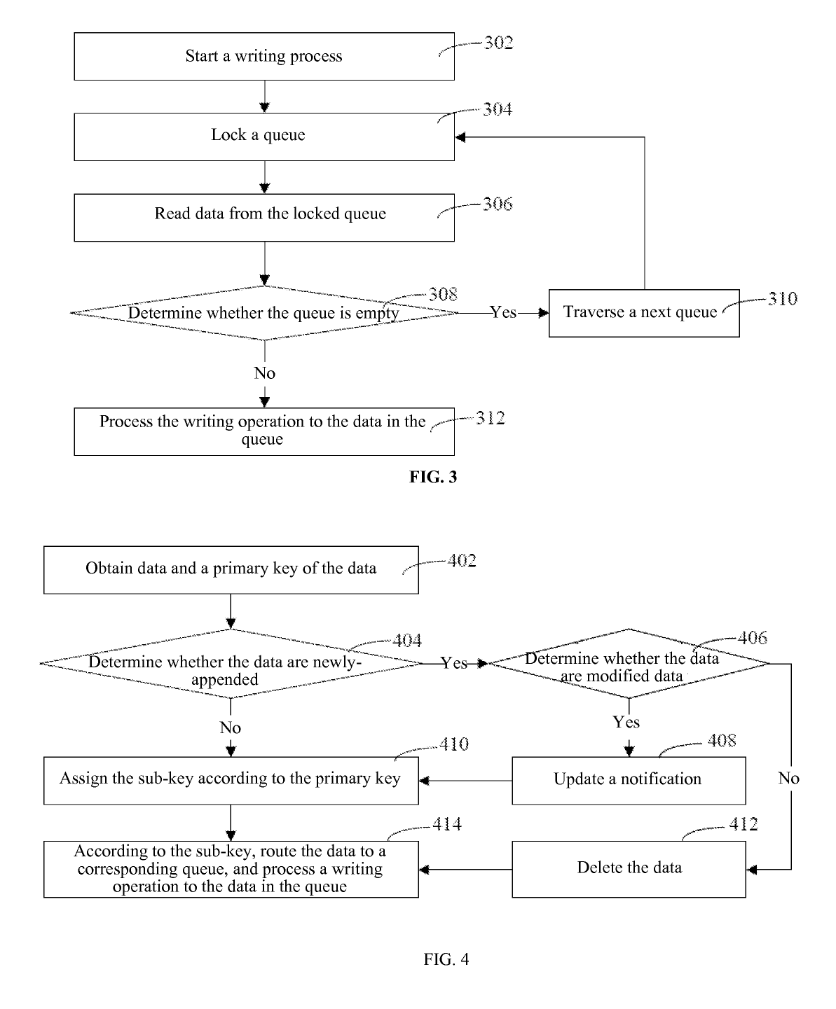

FIG. 4 depicts another exemplary method for data distribution and concurrence consistent with various disclosed embodiments.

In Step 402, data and a primary key of the data can be obtained. In Step 404, it is determined whether the data are newly-appended data. When the data is determined to be newly appended, Step 410 can be implemented. When the data is determined not to be newly appended, Step 406 can be implemented.

For example, the data can be determined to be a newly-appended data by calling an interface for newly-appended data. In addition, the data can be determined to be newly-appended according to a Hash value comparison.

In Step 406, it is determined whether the data are modified data. When the data are determined to be modified, Step 408 can be implemented. When the data are determined not to be modified, Step 412 can be implemented. For example, the data can be determined to be modified data through by calling an interface for the modified data.

In Step 408, a notification can be updated. Step 410 can then be implemented. For example, the updating notification can include deleting an old notification and adding a new-notification.

In Step 410, the sub-key can be assigned according to the primary key. Step 414 can be implemented. In Step 412, the data can be deleted. Step 414 can then be implemented. In Step 414, according to the sub-key, the data can be routed to a corresponding queue, and processing a writing operation to the data in the queue.

In disclosed method for data distribution and concurrence, obtained data can be determined and distinguished to be newly-appended data and modified data. If the data are not the newly-appended data or the modified data, there is no need to assign the sub-key. System resources can be saved.

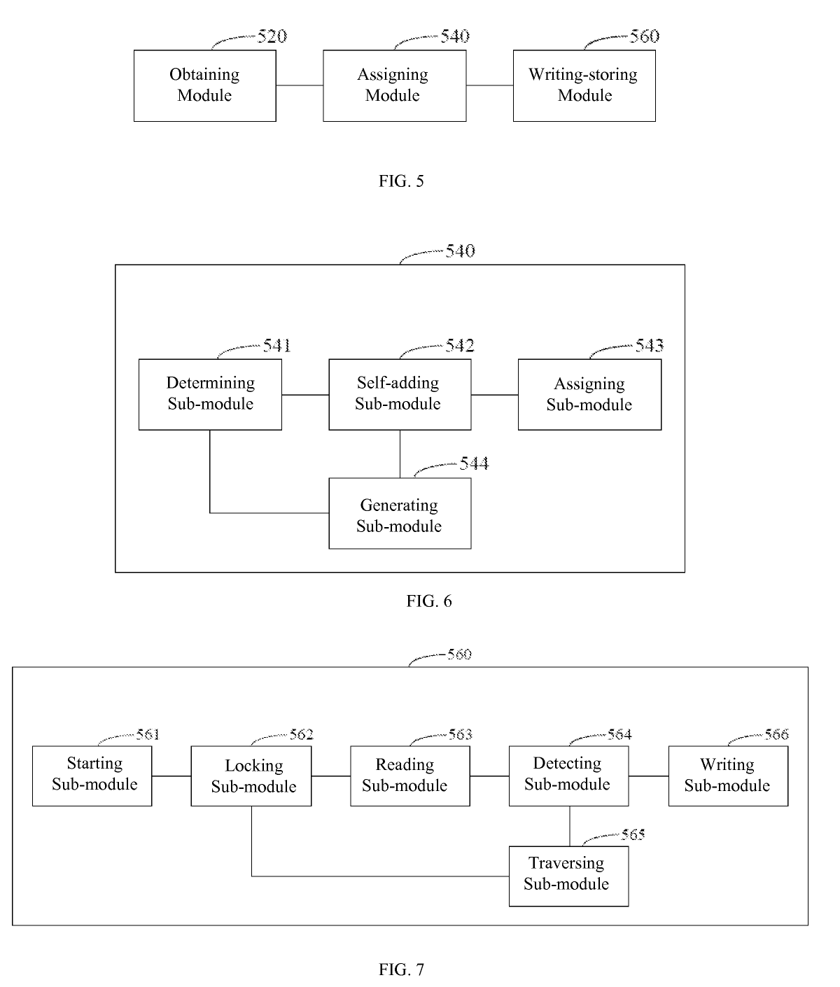

FIG. 5 depicts an exemplary apparatus for data distribution and concurrence consistent with various disclosed embodiments. The exemplary apparatus can include an obtaining module 520, an assigning module 540, and/or a writing-storing module 560.

The obtaining module 520 can be configured to obtain data and a primary key of the data. For example, the data can be any notification data that need to be sent out. The data can include, e.g., a birthday notification, an information notification, etc. In one example, the primary key of the data can be specific notification time, such as at around 10:10 on Aug. 13, 2013.

The assigning module 540 can be configured to assign a sub-key according to the primary key. For example, the primary key can be divided into multiple sub-keys, which can be assigned correspondingly to the data. The primary key can be an index of a storing system for the notification data and used to manage the sub-keys.

FIG. 6 depicts an internal structure of an exemplary assigning module consistent with various disclosed embodiments. An exemplary assigning module 540 can include a determining sub-module 541, a self-adding sub-module 542, an assigning sub-module 543, and/or a generating sub-module 544.

The determining sub-module 541 can be configured to determine whether a grouping ID of the primary key exists. When the grouping ID of the primary key exists, whether a sub-key under the grouping ID exists can be further determined.

The self-adding sub-module 542 can be configured to add one to a record number under the sub-key, when the sub-key is determined that exists under the grouping ID. The assigning sub-module 543 can be configured to return the sub-key. The generating sub-module 544 can be configured to generate the sub-key under the grouping ID, when the sub-key does not exist under the grouping ID.

The self-adding sub-module 542 can be further configured to add one to a record number under the generated sub-key, after the sub-key under the grouping ID is generated. The assigning sub-module 543 is further configured to return the generated sub-key. The generating sub-module 544 can further be configured to assign a grouping ID to the primary key, and to generate a sub-key under the generated grouping ID, when the grouping ID of the primary is determined that does not exist.

The self-adding sub-module 542 can further be configured to add one to a data-record number under the sub-key. The assigning sub-module 543 can further be configured to return the generated sub-key. The determining sub-module 541 can further be configured, after the sub-key is determined under the grouping ID, to determine whether a data-record number of the sub-key is greater than or equal to a pre-set value.

The self-adding sub-module 542 can further be configured, when the data-record number of the sub-key is determined to be greater than or equal to the pre-set value, to add one to the sub-key under the grouping ID to provide an updated sub-key, and to add one to the-data record number under the updated sub-key.

The assigning sub-module 543 can further be configured to return the updated sub-key. The self-adding sub-module 542 can further be configured to add one to the data-record number under the sub-key, when the data-record number of the sub-key is determined to be less than the pre-set value. The assigning sub-module 543 can further be configured to return the sub-key. The writing-storing module 560 can be configured, according to the sub-key, to route the data to a corresponding queue, and process a writing operation to the data in the queue.

FIG. 7 depicts an internal structure of an exemplary writing-storing module consistent with various disclosed embodiments. An exemplary writing-storing module 560 can include a starting sub-module 561, a locking sub-module 562, a reading sub-module 563, a detecting sub-module 564, a traversing sub-module 565, and/or a writing sub-module 566.

The starting sub-module 561 can be configured to start a writing process. The locking sub-module 562 can be configured to lock a queue. The reading sub-module 563 can be configured to read data from the locked queue. The detecting sub-module 564 can be configured to determine whether the queue is empty. The traversing sub-module 565 can be configured to traverse a next queue, when the queue is determined to be empty. The locking sub-module 562 can be further configured to re-lock the traversed queue. The writing sub-module 566 can be configured to process the writing operation to the data in the queue, when the queue is determined not to be empty.

In the disclosed apparatus for data distribution and concurrence, by assigning a corresponding sub-key according to a primary key of the data, the data of each sub-key can be routed to a corresponding queue to process a writing operation to the data in the queue. Because multiple sub-keys exist under a same primary key and each sub-key can only have one place (e.g., the queue) for the writing operation, the writing operation can be processed simultaneously to the multiple sub-keys without affecting one another. The success rate of data writing concurrence can be improved and timeliness of the data can be ensured.

FIG. 8 depicts another exemplary apparatus for data distribution and concurrence consistent with various disclosed embodiments. An exemplary apparatus can further include a determining module 530, an updating module 532, and/or a deleting module 534, in addition to the obtaining module 520, the assigning module 540, and the writing-storing module 560.

The determining module 530 can be configured to determine whether the data are newly appended data, after obtaining the data and the primary key of the data. The assigning module 540 can further be configured to assign the sub-key according to the primary key, when the data is determined to be newly appended. The determining module 530 can further be configured to further determine whether the data are modified data, when the data is determined not to be newly appended.

The updating module 532 can be configured to update a notification, when the data are determined to be modified. The assigning module 540 can further be configured to assign the sub-key according to the primary key, when the data are determined to be modified. The deleting module 534 can be configured to delete the data, when the data are determined not to be modified.

In disclosed apparatus for data distribution and concurrence, obtained data can be determined and distinguished to be newly-appended data and modified data. If the data are not the newly-appended data or the modified data, there is no need to assign the sub-key. System resources can be saved.

In various embodiments, the methods for data distribution and concurrence can be implemented by an apparatus including one or more processors and a non-transitory computer-readable storage medium. The non-transitory computer-readable storage medium can include instructions (or programs) stored thereon. When being executed, the instructions can cause the one or more processors of the apparatus to perform the method.

In a certain embodiment, the disclosure mainly solves the problem of the high concurrence, when the qq-notification stores reverse data. Timeliness of the notification data can be ensured and the success rate for appending data can be improved.

For example, a reverse primary key (or a primary key) can be refined and divided into multiple sub-keys, then a writing operation of each sub-key can only be performed by a certain progress (e.g., in a queue), to realize success rate of concurrence writing. Dividing of the primary key and the writing-storing are all stateless. Tmem is often used by data storage companies. The Tmem has four modules including a data receiving module, a key assigning module, a writing-storing module, and a storing module Tmem. When the data needs to be written into the storage, the data receiving module can receive the data and then apply for a reverse storage key from the key assigning module. According to the key, a corresponding writing-storing module can be routed thereto. In this module, each key can only be written into a corresponding queue, and each queue can only allow one writing-process to read. The data can then be returned to the Tmem. This can ensure that each sub-key only has one place for the writing operation.

FIG. 9 depicts an exemplary environment 900 incorporating certain disclosed embodiments. As shown in FIG. 9, environment 900 can include a server 904, a client (and/or a terminal) 906, and a communication network 902. The server 904 and the client 906 may be coupled through the communication network 902 for information exchange, such as webpage browsing, Internet searching, data downloading, etc. Although only one client 906 and one server 904 is shown in the environment 900, any number of clients 906 or servers 904 may be included, and other devices may also be included.

Communication network 902 may include any appropriate type of communication network for providing network connections to the server 904 and client 906 or among multiple servers 904 or clients 906. For example, communication network 902 may include the Internet or other types of computer networks or telecommunication networks, either wired or wireless.

A client can be installed in any user terminal. In some cases, a client may refer to any appropriate user terminal with certain computing capabilities, such as a personal computer (PC), a work station computer, a server computer, a hand-held computing device (tablet), a smart phone or mobile phone, or any other user-side computing device.

A server, as used herein, may refer one or more server computers configured to provide certain server functionalities, such as database management and search engines. A server may also include one or more processors to execute computer programs in parallel.

In one example, data (e.g., event) notifications can be transmitted between client/terminal (including applications) and a server. The data notifications can include a game notification, a birthday notification, an information notification, etc.

The server 904 and the client 906 may be implemented on any appropriate computing platform. FIG. 10 shows a block diagram of an exemplary computer system 1000 capable of implementing the server 904 and/or the client 906. As shown in FIG. 10, the exemplary computer system 1000 may include a processor 1002, a storage medium 1004, a monitor 1006, a communication module 1008, a database 1010, peripherals 1012, and one or more bus 1014 to couple the devices together. Certain devices may be omitted and other devices may be included.

Processor 1002 can include any appropriate processor or processors. Further, processor 1002 can include multiple cores for multi-thread or parallel processing. Storage medium 1004 may include memory modules, such as ROM, RAM, and flash memory modules, and mass storages, such as CD-ROM, U-disk, removable hard disk, etc. Storage medium 1004 (e.g., a non-transitory computer-readable storage medium) may store computer programs for implementing various processes, when executed by processor 1002.

Further, peripherals 1012 may include I/O devices such as keyboard and mouse, and communication module 1008 may include network devices for establishing connections through the communication network 902. Database 910 may include one or more databases for storing certain data and for performing certain operations on the stored data, such as webpage browsing, database searching, etc.

In operation, client 906 may cause server 904 to perform certain actions, such as an Internet search or other database operations. Server 904 may be configured to provide structures and functions for such actions and operations. More particularly, server 904 may include a data searching system for real-time database searching.

In various embodiments, the disclosed methods can be implemented by an apparatus for data distribution and concurrence including one or more processor, and a non-transitory computer-readable storage medium having instructions stored thereon. The instructions can be executed by the one or more processors of the apparatus to implement the methods disclosed herein. In some cases, the instructions can include one or more modules (e.g., an obtaining module, an assigning module, and a writing-storing module) corresponding to the disclosed methods.

It should be understood that steps described in various methods of the present disclosure may be carried out in order as shown, or alternately, in a different order. Therefore, the order of the steps illustrated should not be construed as limiting the scope of the present disclosure. In addition, certain steps may be performed simultaneously.

In the present disclosure each embodiment is progressively described, i.e., each embodiment is described and focused on difference between embodiments. Similar and/or the same portions between various embodiments can be referred to with each other. In addition, exemplary apparatus and/or systems are described with respect to corresponding methods.

The disclosed methods, apparatus, and/or systems can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

As used herein, the term “module” or “unit” can be software objects executed on a computing system. A variety of components described herein including elements, modules, units, engines, and services can be executed in the computing system. The methods, apparatus, and/or systems can be implemented in a software manner. Of course, the methods, apparatus, and/or systems can be implemented using hardware. All of which are within the scope of the present disclosure.

A person of ordinary skill in the art can understand that the units/modules included herein are described according to their functional logic, but are not limited to the above descriptions as long as the units/modules can implement corresponding functions. Further, the specific name of each functional module is used to be distinguished from one another without limiting the protection scope of the present disclosure.

In various embodiments, the disclosed units/modules can be configured in one apparatus (e.g., a processing unit) or configured in multiple apparatus as desired. The units/modules disclosed herein can be integrated in one unit/module or in multiple units/modules. Each of the units/modules disclosed herein can be divided into one or more sub-units/modules, which can be recombined in any manner. In addition, the units/modules can be directly or indirectly coupled or otherwise communicated with each other, e.g., by suitable interfaces.

One of ordinary skill in the art would appreciate that suitable software and/or hardware (e.g., a universal hardware platform) may be included and used in the disclosed methods, apparatus, and/or systems. For example, the disclosed embodiments can be implemented by hardware only, which alternatively can be implemented by software products only. The software products can be stored in computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods and apparatus for data distribution and concurrence are provided. Data and a primary key of the data can be obtained. A sub-key can be assigned according to the primary key. The data can be routed to a corresponding queue according to the sub-key. A writing operation can be processed to the data in the queue. In this manner, obtained data can be determined and distinguished to be newly-appended data and/or modified data. If the data are not the newly-appended data or the modified data, there is no need to assign the sub-key. System resources can be saved.

The disclosed methods and apparatus can assign a corresponding sub-key according to a primary key of the data, then route the data of each sub-key to a corresponding queue, and then process a writing operation to the data in the queue. Because multiple sub-keys exist under a same primary key and each sub-key can only have one place (e.g., the queue) for the writing operation, the writing operation can be processed simultaneously to the multiple sub-keys without affecting one another. The success rate of data writing concurrence can be improved and timeliness of the data can be ensured.

What is claimed is:

1. A data distribution and concurrence method, comprising:
obtaining data and a primary key of the data;
assigning a sub-key according to the primary key; and
according to the sub-key, routing the data to a corresponding queue, and processing a writing operation to the data in the queue.

2. The method according to claim 1, wherein the step of assigning the sub-key according to the primary key comprises:
determining whether a grouping ID of the primary key exists,
when the grouping ID of the primary key exists, further determining whether the sub-key under the grouping ID exists,
when the sub-key exists under the grouping ID, adding one to a record number under the sub-key, and returning the sub-key, and
when the sub-key does not exist under the grouping ID, generating the sub-key under the grouping ID, and adding one to a record number under the generated sub-key, and returning the generated sub-key.

3. The method according to claim 2, wherein the step of assigning the sub-key according to the primary key comprises:
when the grouping ID of the primary is determined that does not exist, assigning the grouping ID to the primary key,
generating the sub-key under the generated grouping ID,
adding one to a data-record number under the sub-key, and
returning the generated sub-key.

4. The method according to claim 2, wherein after the step of determining that the sub-key exists under the grouping ID, the method further comprises:
determining whether a data-record number of the sub-key is greater than or equal to a pre-set value,
when the data-record number of the sub-key is determined to be greater than or equal to the pre-set value, adding one to the sub-key under the grouping ID to provide an updated sub-key, and adding one to the data-record number under the updated sub-key, and returning the updated sub-key, and
when the data-record number of the sub-key is determined not to be greater than or equal to the pre-set value, adding one to the data-record number under the sub-key, and returning the sub-key.

5. The method according to claim 1, wherein the step of processing the writing operation to the data in the queue comprises:
starting a writing process,
locking a queue,
reading data from the locked queue,
determining whether the queue is empty,
when the queue is determined to be empty, traversing a next queue, and re-locking the traversed queue, and
when the queue is determined not to be empty, processing the writing operation to the data in the queue.

6. The method according to claim 1, wherein after the step of obtaining the data and the primary key of the data and before the step of assigning the sub-key according to the primary key, the method further comprises:
determining whether the data are newly-appended data,
when the data is determined to be newly appended, assigning the sub-key according to the primary key,
when the data is determined not to be newly appended, further determining whether the data are modified data,
when the data are determined to be modified, updating a notification, and assigning the sub-key according to the primary key, and
when the data are determined not to be modified, deleting the data.

7. A data distribution and concurrence apparatus, comprising:
an obtaining module, configured to obtain data and a primary key of the data;
an assigning module, configured to assign a sub-key according to the primary key; and
a writing-storing module, configured to route the data to a corresponding queue, and to process a writing operation to the data in the queue, according to the sub-key.

8. The apparatus according to claim 7, wherein the assigning module comprises:
a determining sub-module, configured to determine whether a grouping ID of the primary key exists, and when the grouping ID of the primary key exists, to further determine whether a sub-key under the grouping ID exists,
a self-adding sub-module, configured to add one to a record number under the sub-key, when the sub-key is determined to exist under the grouping ID,
an assigning sub-module, configured to return the sub-key, and
a generating sub-module, configured to generate the sub-key under the grouping ID, when the sub-key does not exist under the grouping ID, wherein the self-adding sub-module is further configured, after the sub-key under the grouping ID is generated, to add one to a record number under the generated sub-key, and wherein the assigning sub-module is further configured to return the generated sub-key.

9. The apparatus according to claim 8, wherein:
the generating sub-module is further configured to assign a grouping ID to the primary key, and generate a second sub-key under the generated grouping ID, when the grouping ID of the primary is determined that does not exist,
the self-adding sub-module is further configured to add one to a data-record number under the sub-key, and
the assigning sub-module is further configured to return the generated sub-key.

10. The apparatus according to claim 8, wherein:
the determining sub-module is further configured, after the sub-key is determined under the grouping ID, to determine whether a data-record number of the sub-key is greater than or equal to a pre-set value,
the self-adding sub-module is further configured, when the data-record number of the sub-key is determined to be greater than or equal to the pre-set value, to add one to the sub-key under the grouping ID to provide an updated sub-key, and to add one to the-data record number under the updated sub-key,
the assigning sub-module is further configured to return the updated sub-key,
the self-adding sub-module is further configured to add one to the data-record number under the sub-key, when the data-record number of the sub-key is determined to be less than the pre-set value, and
the assigning sub-module is further configured to return the sub-key.

11. The apparatus according to claim 7, wherein the writing-storing module comprises:
a starting sub-module, configured to start a writing process,
a locking sub-module, configured to lock a queue,
a reading sub-module, configured to read data from the locked queue,
a detecting sub-module, configured to determine whether the queue is empty,
a traversing sub-module, configured to traverse a next queue, when the queue is determined to be empty, wherein the locking sub-module is further configured to re-lock the traversed queue, and
a writing sub-module, configured to process the writing operation to the data in the queue, when the queue is determined not to be empty.

12. The apparatus according to claim 7, further comprising:
a determining module, configured to determine whether the data are newly appended data after obtaining the data and the primary key of the data, wherein the assigning module is further configured to assign the sub-key according to the primary key, when the data is determined to be newly appended, and wherein the determining module is further configured to further determine whether the data are modified data, when the data is determined not to be newly appended,
an updating module, configured to update a notification when the data are determined to be modified, wherein the assigning module is further configured to assign the sub-key according to the primary key when the data are determined to be modified, and
a deleting module, configured to delete the data, when the data are determined not to be modified.

13. The apparatus according to claim 8, further comprising one or more processors and a non-transitory computer-readable storage medium having instructions stored thereon, the instructions executed by the one or more processors and comprising the obtaining module, the assigning module, and the writing-storing module.

14. A non-transitory computer-readable medium having computer program for, when being executed by a processor, performing a data distribution and concurrence method, the method comprising:
obtaining data and a primary key of the data;
assigning a sub-key according to the primary key; and
according to the sub-key, routing the data to a corresponding queue, and processing a writing operation to the data in the queue.

15. The non-transitory computer-readable medium according to claim 14, wherein the step of assigning the sub-key according to the primary key comprises:
determining whether a grouping ID of the primary key exists,
when the grouping ID of the primary key exists, further determining whether the sub-key under the grouping ID exists,
when the sub-key exists under the grouping ID, adding one to a record number under the sub-key, and returning the sub-key, and
when the sub-key does not exist under the grouping ID, generating the sub-key under the grouping ID, and adding one to a record number under the generated sub-key, and returning the generated sub-key.

16. The non-transitory computer-readable medium according to claim 15, wherein the step of assigning the sub-key according to the primary key comprises:
when the grouping ID of the primary is determined that does not exist, assigning the grouping ID to the primary key,
generating the sub-key under the generated grouping ID,
adding one to a data-record number under the sub-key, and
returning the generated sub-key.

17. The non-transitory computer-readable medium according to claim 15, wherein after the step of determining that the sub-key exists under the grouping ID, the method further comprises:
determining whether a data-record number of the sub-key is greater than or equal to a pre-set value,
when the data-record number of the sub-key is determined to be greater than or equal to the pre-set value, adding one to the sub-key under the grouping ID to provide an updated sub-key, and adding one to the data-record number under the updated sub-key, and returning the updated sub-key, and
when the data-record number of the sub-key is determined not to be greater than or equal to the pre-set value, adding one to the data-record number under the sub-key, and returning the sub-key.

18. The non-transitory computer-readable medium according to claim 14, wherein the step of processing the writing operation to the data in the queue comprises:
starting a writing process,
locking a queue,
reading data from the locked queue,
determining whether the queue is empty,
when the queue is determined to be empty, traversing a next queue, and re-locking the traversed queue, and
when the queue is determined not to be empty, processing the writing operation to the data in the queue.

19. The non-transitory computer-readable medium according to claim 14, wherein after the step of obtaining the data and the primary key of the data and before the step of assigning the sub-key according to the primary key, the method further comprises:
determining whether the data are newly-appended data,
when the data is determined to be newly appended, assigning the sub-key according to the primary key,
when the data is determined not to be newly appended, further determining whether the data are modified data,
when the data are determined to be modified, updating a notification, and assigning the sub-key according to the primary key, and
when the data are determined not to be modified, deleting the data.
